(19) United States
(12) Patent Application Publication
(10) Pub. No.: US 2015/0085187 A1
(43) Pub. Date: Mar. 26, 2015

(54) METHOD AND APPARATUS FOR BURST MODE VIDEO PROCESSING WITH INBAND LINK POWER MANAGEMENT

(71) Applicants: Huimin Chen, Portland, OR (US); George R. Hayek, El Dorado Hills, CA (US); Robert Jamie Johnston, Carmichael, CA (US); Pravas Pradhan, Bangalore (IN); Satyanarayana Avadhanam, El Dorado Hills, CA (US); Seh W. Kwa, Saratoga, CA (US)

(72) Inventors: Huimin Chen, Portland, OR (US); George R. Hayek, El Dorado Hills, CA (US); Robert Jamie Johnston, Carmichael, CA (US); Pravas Pradhan, Bangalore (IN); Satyanarayana Avadhanam, El Dorado Hills, CA (US); Seh W. Kwa, Saratoga, CA (US)

(21) Appl. No.: 14/032,846

(22) Filed: Sep. 20, 2013

(51) Int. Cl. H04N 5/63; H04N 5/38; H04N 5/44; H04N 7/01

(52) U.S. Cl. CPC H04N 5/63; H04N 7/0127; H04N 5/38; H04N 5/44
USPC 348/441

(57) ABSTRACT

An electronic device, method, and at least one machine readable medium for burst mode processing of video data with inband link power management are provided herein. The method includes receiving a pixel stream, transferring the received stream as currently-available frame-formatted video data to a sink in burst at high data rate, and entering a reduced-power operating state until transfer of additional currently-available video data is enabled. The method may include issuing inband command signals to cause the link to enter into and exit from the reduced-power link operating states.

### TECHNICAL FIELD

The present techniques relate generally to video display and processing systems and devices that include such systems. More particularly, the present techniques relate to a method and apparatus for a burst mode video system with inband power link management.

### BACKGROUND ART

Video processing and display systems, such as those used in computers and other electronic devices, transmit packetized video data from a source, such as a video player or computer graphics processing unit, that provides a stream of video data to a sink system, which may include a display panel or recorder, at a predetermined throughput rate defined by a standard, such as the DisplayPort video interface standard developed by the Video Electronics Standards Association. However, the actual throughput required at any given display application may not match the predetermined throughput defined by the standard. Accordingly, additional non-video data, referred to as idle patterns, may sometimes be added to synchronize the video data to be transmitted with the standard's predetermined throughput to thereby offset any throughput mismatch. Adding idle patterns, however, increases power consumption and precludes an opportunity to reduce power consumption when frame buffer compression results in variable frame buffer size.

Interface standards, such as DisplayPort, may incorporate a power management scheme intended to reduce the power consumed by video processing and transmission systems by causing the components of the transmission link to enter one or more reduced or low-power operating states. Entry into the reduced or low-power operating states may be triggered by an inband signal (a signal carried on the same channel as the video data also referred to as the main video channel) whereas exit from the low power operating states is triggered by a sideband signal that is not transmitted on the main video channel but rather is transmitted on a bi-directional auxiliary channel that operates in the half-duplex mode and which carries other device management and control signals. Using a sideband signal carried on the auxiliary channel to exit from the low-power operating states requires that the auxiliary channel not be in use and be available to carry the sideband exit signal when exit from the low-power operating state is desired. If the auxiliary channel is in use when exit from the low-power operating state is desired there may be a delay in issuing the sideband exit signal until the auxiliary channel becomes available to carry that signal. Thus, latency may occur in exiting from the low-power operating states. Latency may also result from the need to synchronize the main video data link/channel upon exit from a low-power state. This latency compromises the ability to manage and reduce power consumption in the video data link.

### BRIEF DESCRIPTION OF THE DRAWINGS

FIG. 1 is a block diagram of an electronic device having a burst mode video system with inband link power management;

FIG. 2 is a detail view of the burst mode video system with inband link power management of FIG. 1;

FIG. 3 is a detail view of the burst mode video system with inband link power management of FIG. 1;

FIG. 4 is a detail view of the burst mode video system with inband link power management of FIG. 1;

FIG. 5 is a process flow diagram of a method of inband link power management; and

FIG. 6 is a process flow diagram of a method of burst mode video processing with inband link power management.

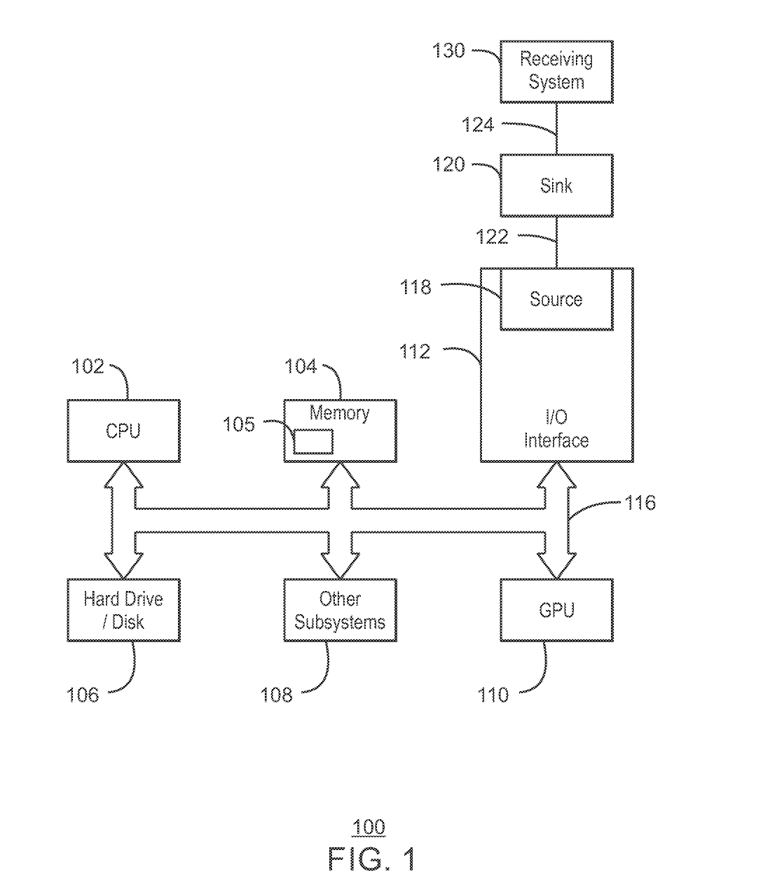

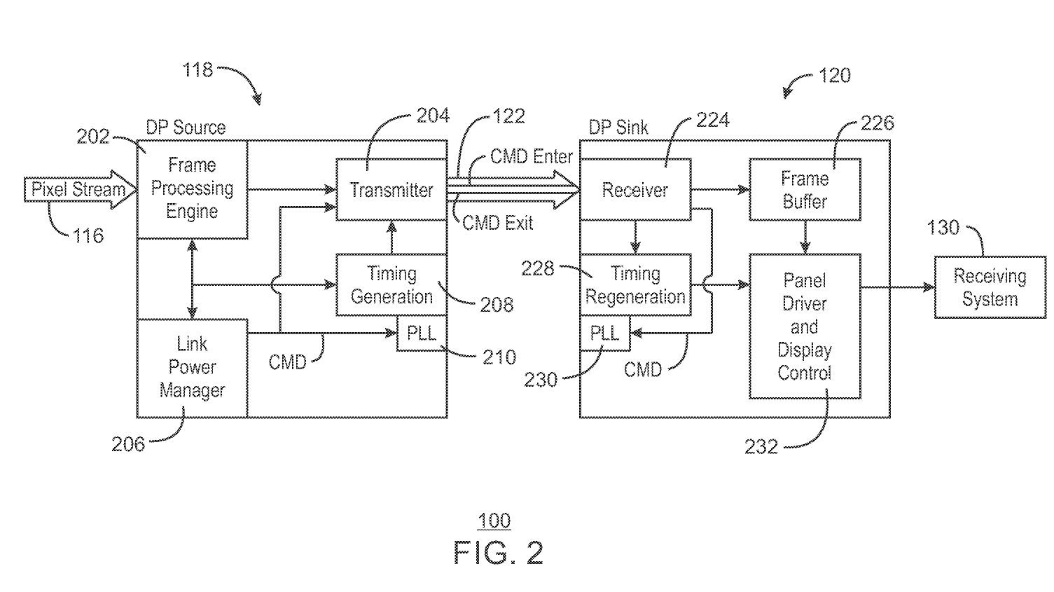

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an electronic device 100 having a burst mode video processing system with inband link power management. Electronic device 100 may be virtually any type of electronic device that processes video data including, for example and without limitation, a computer, television, video player or receiver, gaming console, and the like. Electronic device 100 may include a central processing unit or CPU 102 and one or more memory devices 104. CPU 102 may be a conventional CPU capable of reading and executing instructions, including instructions stored in memory device 104. Memory device 104 may be configured as random access memory, read only memory, flash memory, EEPROM, removable memory such as an SD card or USB memory stick, or any combination of the foregoing. Memory device 104 includes a non-transitory medium that stores computer-readable instructions 105 that are executable by CPU 102, and which will be more particularly described hereinafter.

Electronic device 100 may also include a hard disc drive 106. Electronic device 100 may further include various other subsystems indicated at 108, including for example interface circuitry to connect peripheral devices such as a keyboard or mouse (not shown) and the like. Electronic device 100 may also include a graphics processing unit or GPU 110 for processing video data and an input/output (I/O) interface system 112. Each of CPU 102, memory 104, hard disc drive 106, subsystems 108, GPU 110 and I/O interface system 112 are interconnected via a signal bus 116, such as, for example, an ISA, EISA or SCSI bus. I/O interface system 112 includes source system 118, which will be more particularly described in connection with FIG. 2. Source system 118 is interconnected with sink system 120 via a video data bus 122, which may be in the form of a connector cable, such as, for example, a connector and cable compatible with the DisplayPort video interface standard. Sink system 120 is interconnected via a video signal bus 124 to a receiving system 130, such as, for example, a television, display panel, computer monitor, video recorder or storage device, or other video display or recording element. Sink system 120 may be integral with or separate from the receiving system 130. Sink system 120 is also described in more detail in connection with FIG. 2.

FIG. 2 is a block diagram showing additional detail of the source system 118 and the sink system 120. Source system 118 includes frame processing engine 202, transmitter 204, link power manager 206, timing generator 208 and phase lock loop (PLL) 210. Source system 118 receives via signal bus 116 a stream of video/pixel data. The stream of video/pixel data is processed or formatted into frames of video data by frame processing engine 202. The formatted frames of video data are transferred by transmitter 204 via the video data bus 122 to sink 120 based at least in part upon the outgoing video timing determined by timing generator 208. PLL 210 generates timing and clock signals that are provided to timing generator 208. PLL 210 may, in embodiments, be a standalone element or may be integral with timing generator 208.

Sink system 120 includes receiver 224, frame buffer 226, timing regenerator 228, phase lock loop (PLL) 230 and driver and control circuitry 232. Receiver 224 receives the formatted frames of video data via video data bus 122. Timing regenerator 228 with PLL 230 regenerates the timing and clock signals to synchronize the received formatted frames of video data. PLL 230 may be separate from or integral with timing generator 228. Frame buffer 226 stores frames of video data for provision to driver and control circuitry 232. Driver and control circuitry 232 transfers the frames of video data to receiving system 130 in accordance with the timing parameters generated by timing regenerator 228, and includes logic to control the operation of receiving system 130. In embodiments, receiving system 130 may be a television or other display element or panel, a video recorder, or other device configured to receive, store and/or display or otherwise process video data.

It should be particularly noted that the video data is transmitted from source 118 to sink 120, and in embodiments from source 118, to sink 120, and to receiving system 130 in a burst at a high data transfer rate. As used herein, a burst, burst transfer, burst mode, and variants thereof, refer to transferring video data in blocks or groups of video data. The size of the blocks or groups of video data transferred in burst mode is dependent at least in part upon the throughput of the link 122, the size of the frame buffer 226, the actual rate at which the receiving system 130 may accept or receive and process pixels, and the capability of the frame processing engine 202. In embodiments where the receiving system 130 is a display panel, the rate at which the display may receive and process pixels is dependent at least in part upon the display rate of the panel.

The link power manager 206 issues, in embodiments, inband command signals CMD-ENTER and CMD-EXIT to source system 118 and to sink system 120 via transmitter 204 and video data bus 122 to cause the source and sink systems 118 and 120 to enter into and exit, respectively, one of a plurality of predetermined reduced-power operating states. The link power manager 206 determines or selects one of the plurality of predetermined reduced-power operating states based at least in part upon the inter-frame idle duration of the video data, which may be determined by the frame size within each frame interval relative to the rate of data throughput of which video data bus 122 is capable, and issues the inband command signal CMD-ENTER corresponding to the selected reduced-power operating state. The plurality of predetermined operating states, as well as the corresponding operating conditions of the components of sink and source systems 118 and 120, respectively, will be more particularly described hereinafter.

Inband command signal CMD-ENTER may, in embodiments, be a command-based instruction causing source and sink systems 118 and 120 to enter a designated one of the plurality of predetermined reduced-power operating states. The inband command signal CMD-ENTER may, in embodiments, be embedded in the end of frame packet in a pre-designated command field. The command signal CMD-ENTER may, in embodiments, be received by or provided to transmitter 204, PLL 210, receiver 224 and timing regenerator 228, while in other embodiments additional functional blocks of the sink and source systems 118 and 120, respectively, may also receive or be provided with the command signal CMD-ENTER.

Inband Command signal CMD-EXIT may, in certain embodiments, be an inband low-frequency periodic signal capable of being transmitted and received in an AC-coupled link at relatively low power levels thereby reducing power consumption compared to conventional link signaling/control methods. In other embodiments, inband command signal CMD-EXIT may be a DC pulse signal in a DC-coupled link having a variety of predetermined pulse width durations, each predetermined pulse width duration corresponding to a respective one of the predetermined reduced-power operating states of the sink and source systems 118 and 120. The command signal CMD-EXIT may, in embodiments, be received by or provided to transmitter 204, PLL 210, receiver 224 and timing regenerator 228, while in other embodiments additional functional blocks of the sink and source systems 118 and 120, respectively, may also receive or be provided with the command signal CMD-EXIT.

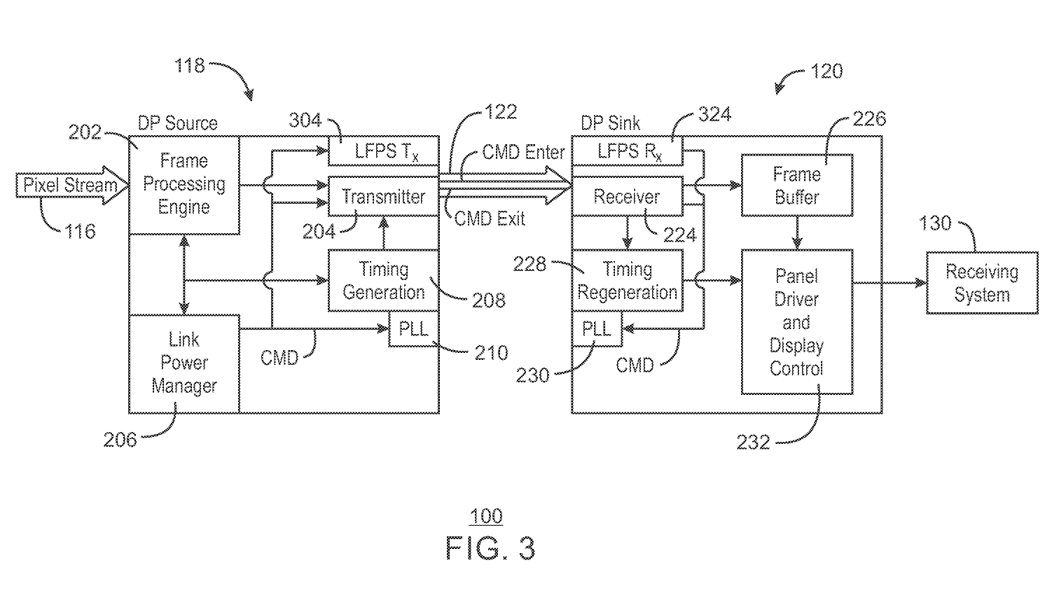

FIG. 3 is a block diagram showing an alternate embodiment of sink and source systems 118 and 120, respectively. More particularly, in embodiments, source system 118 may include a low frequency periodic signal transmitter (LFPS Tx) 304 and sink system 120 may include a low frequency periodic signal receiver (LFPS Rx) 324 for sending and receiving, respectively, the inband command signal CMD-EXIT via video data bus 122. Each of the LFPS Tx 304 and LFPS Rx 324 may be respectively integral with or separate and distinct from the corresponding transmitter 204 and receiver 224. In either case, the LFPS Tx 304 and LFPS Rx 324 may be separately controlled from transmitter 204 and receiver 224, and at any time may be caused by the inband command signal CMD-EXIT to exit from a predetermined low-power operating state. LFPS Tx 304 may, in embodiments, be configured as a low or very low power transmitter relative to transmitter 204, and similarly LFPS Rx 324 may also be a low or very low power receiver relative to receiver 224, thereby reducing the power consumed by the sink and source systems 118 and 120, respectively. LFPS Tx 304 and LFPS Rx 324 may, in embodiments, require only microwatts of power.

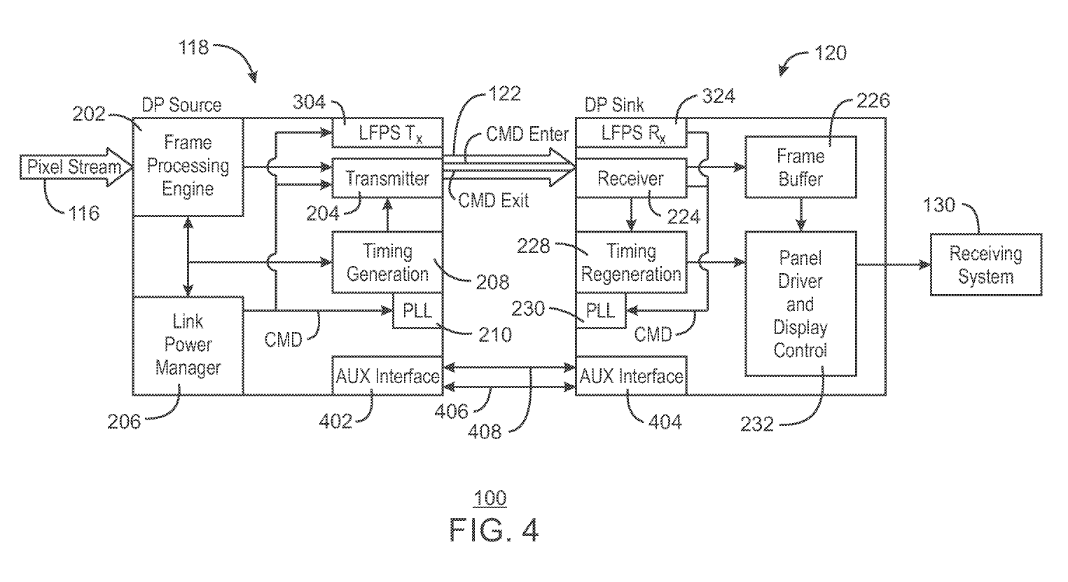

FIG. 4 is a block diagram of a source system 118 and sink system 120. More particularly, FIG. 4 illustrates the source and sink systems 118 and 120, respectively, in a configuration that is consistent with the DisplayPort video interface standard in that the source system 118 includes an AUX interface 402 and the sink system 324 includes an AUX interface 404, each of which exchange signals via an AUX signal link 406 and an HPD link 408. As in the embodiments described above, the inband command signals CMD-ENTER and CMD-EXIT are issued to sink system 118 and to source system 122 via transmitter 204 and video data bus 122 to cause the source and sink systems 118 and 120 to enter and exit, respectively, one of the plurality of predetermined reduced-power operating states, thereby avoiding the potential for collisions and latency that may occur if the AUX signal link 406 was also used to communicate a signal to change operating states of the source and sink systems 118 and 120 as may occur in a conventionally-configured system. In alternate embodiments, however, the command signals CMD-ENTER and CMD-EXIT may be sideband signals, rather than inband signals, carried on the AUX signal link 406.

Table 1 below illustrates exemplary predetermined reduced-power operating states, and the corresponding operating conditions of the components of sink and source systems 118 and 120, with reference to the embodiments shown in FIGS. 3 and 4.

TABLE 1

| | Exemplary Predetermined Reduced-Power Link Operating States | | | |
|---|---|---|---|---|
| | Active | Standby | Sleep | Hibernate |
| Configuration | Transmitter 204: Active; | Transmitter 204: Standby | Transmitter 204: Off | Transmitter 204: Off |
| | Receiver 224: Active; | Receiver 224: Standby | Receiver 224: Off | Receiver 224: Off |
| | LFPS Tx 304: Off; | LFPS Tx 304: On | LFPS Tx 304: On | LFPS Tx 304: On |
| | LFPS Rx 324: Off; | LFPS Rx 324: On | LFPS Rx 324: On | LFPS Rx 324: On |
| | PLL: on | PLL: on | PLL: Off | PLL: Off |
| | Buffer 226: On | Buffer 226: On | Buffer 226: On | Buffer 226: Off |
| | Control 232: On | Control 232: On | Control 232: On | Control 232: Off |
| | Frame Proc Eng 202: On | Frame Proc Eng 202: On | Frame Proc Eng 202: On | Frame Proc Eng 202: Off |
| State Entry | CMD-EXIT | CMD-ENTER(standby) | CMD-ENTER(sleep) | CMD-ENTER(hibernate) |
| State Exit | CMD-ENTER(x) | CMD-EXIT | CMD-EXIT | CMD-EXIT |

The active link operating state is the operating state in which source and sink systems 118 and 120 are actively processing video data. Thus, the source and sink systems 118 and 120 are placed in the active link operating state when the processing of video data is requested. In the active link operating state the functional blocks of sink and source systems 118 and 120 are powered on and operating. The source and sink systems 118 and 120 are placed in the standby link operating state when, for example, there is a discontinuity or pause of relatively brief duration in the need to process video data as determined at least in part by the inter-frame idle duration. In the standby link operating state, in embodiments, the transmitter 204 and receiver 224 may be placed in a reduced-power standby operating mode thereby reducing power consumption. The source and sink systems 118 and 120 are placed in the sleep link operating state when, for example, there is a discontinuity or break of a moderate duration in the need to process video data as determined at least in part by the inter-frame idle duration. In the sleep link operating state, in embodiments, the transmitter 204, receiver 224, and the PLLs 210 and 230 may be powered off to further reduce power consumption. The source and sink systems 118 and 120 are placed in the hibernate link operating state when, for example, there is a discontinuity or break of a significant duration in the need to process video data as determined at least in part by the inter-frame idle duration. In the hibernate link operating state, in embodiments, the transmitter 204, receiver 224, the PLLs 210 and 230, the buffer 226, and the display control 232 may be powered off to still further reduce power consumption.

The source and sink systems are placed into and exit from the various exemplary link operating states shown in and described above in regard to Table 1 by the inband CMD-ENTER and CMD-EXIT signals. More particularly, the source and sink systems 118 and 120 are placed in each of the standby, sleep and hibernate link operating states by a corresponding CMD-ENTER signal. The source and sink systems 118 and 120 are returned to, or otherwise placed in, the active link operating state by an inband CMD-EXIT signal. As discussed above, command signal CMD-ENTER may, in embodiments, be an inband command-based instruction or signal, and the CMD-EXIT signal may, in embodiments, be a low frequency periodic signal, or a DC signal with predetermined pulse width durations with each one of the predetermined pulse width durations corresponding to a respective one of the predetermined reduced-power link operating states.

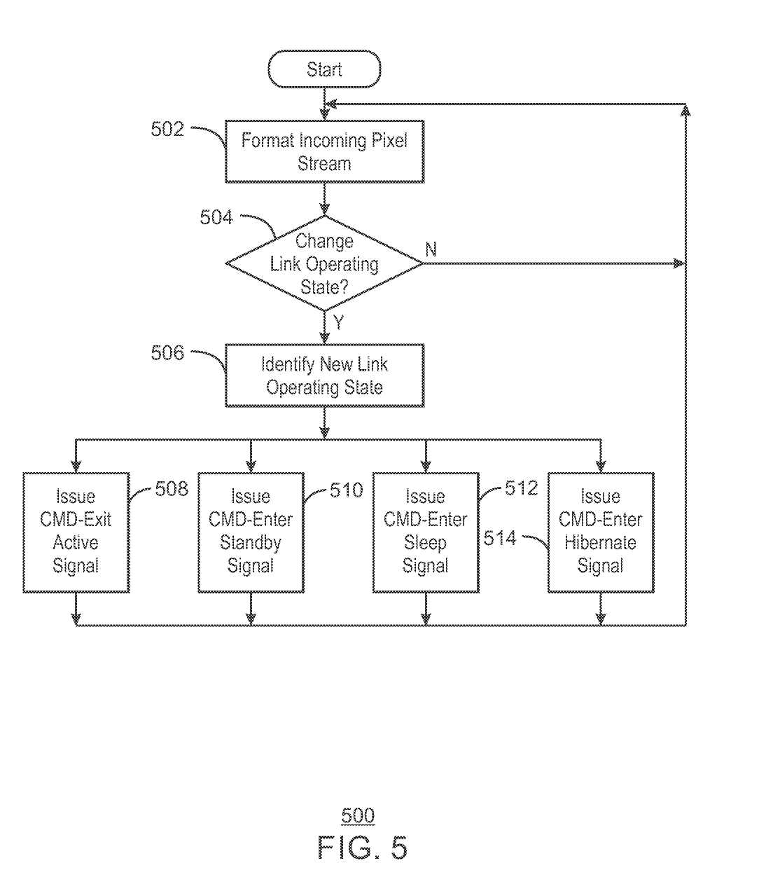

FIG. 5 is a process flow diagram illustrating a method for providing burst mode video processing having inband link power management. In various embodiments, method 500 is performed by, for example, an electronic device such as electronic device 100 of FIG. 1. The method 500 may be embodied by or included in the firmware, operating system, or other operating instructions stored in or provided to such an electronic device, and may be, for example, embodied as machine-readable instructions stored in the memory of the electronic device, such as instructions 105 stored in memory 104 of electronic device 100 of FIG. 1. Method 500 includes formatting incoming pixel stream 502, changing link operating state determination 504, and identifying next link operating state 506.

Formatting incoming pixel stream 502 includes formatting the pixel stream into frames of currently-available video data to support a determination at block 504 as to whether the characteristics of the currently-available video data are appropriate for the current link operating state. Changing link operating state determination 504 determines whether the current link operating state can be changed to a reduced-power link operating state, whether the current link operating state remains the appropriate link operating state, and whether the link operating state should be changed or returned to the active link operating state. Changing link operating state determination 504 determines whether to change the link operating state based at least in part upon the characteristics of the frame-formatted video data including, in embodiments, the amount of data and the inter-frame idle duration. In embodiments, the reduced-power link operating states may include the exemplary predetermined reduced-power link operating states shown in Table 1 and described above.

Upon a determination at block 504 that the current link operating state provides adequate processing capability, and is otherwise appropriate for, the currently-available video data, method 500 iteratively performs blocks 502 and 504 to thereby format any incoming stream of pixels into frame-formatted currently-available video data and to determine whether the current link operating state remains the appropriate link operating state based at least in part upon the characteristics of the frame-formatted video data. Upon a determination at block 504 that the current link operating state should be changed, method 500 proceeds to block 506 where the appropriate new link operating state is identified based on the characteristics of the currently-available video data. The determination of what idle state may be entered depends at least in part upon the current burst size, the link throughput, and the frame period. Method 500 then proceeds to issue a control signal corresponding to the link operating state identified at block 506 to thereby cause the electronic device to enter the identified link operating state.

More particularly, upon a determination at block 506 that the link operating state should be transitioned to the active link operating state method 500 proceeds to issue CMD-EXIT signal at block 508 thereby causing the link operating state to transition to the active link operating state. Upon a determination at block 506 that the link operating state can be transitioned to the standby link operating state, method 500 proceeds to issue at block 510 a CMD-ENTER signal that corresponds to and causes the link to enter the standby link operating state. Similarly, upon a determination at block 506 that the link operating state can be transitioned to the sleep link operating state, method 500 proceeds to issue at block 512 a CMD-ENTER signal that corresponds to and causes the link to enter the sleep link operating state. Upon a determination at block 506 that the link operating state can be transitioned to the hibernate link operating state, method 500 proceeds to issue at block 514 a CMD-ENTER signal that corresponds to and causes the link to enter the hibernate link operating state. Method 500 then continues to iteratively monitor at block 502 the incoming pixel stream and iteratively determine at block 504 whether the current link operating state remains the appropriate link operating state for the incoming pixel stream.

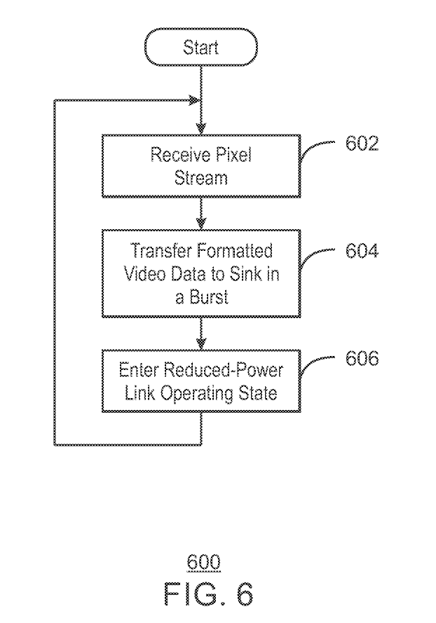

FIG. 6 shows a process flow diagram of a method 600 for burst mode transmission of video data incorporating link power management. In various embodiments, method 600 is performed by, for example, an electronic device such as electronic device 100 of FIG. 1. The method 600 may be embodied by or included in the firmware, operating system, or other operating instructions stored in or provided to such an electronic device, and may be, for example, embodied as machine-readable instructions stored in the memory of the electronic device, such as instructions 105 stored in memory 104 of electronic device 100 of FIG. 1. Method 600 includes receiving pixel stream 602, burst-transferring formatted video data 604 and entering reduced-power link operating state 606.

Receiving pixel stream 602 includes a source, such as source system 118, receiving a stream of pixel data and formatting that data into frames of video data. Transfer formatted video data 604 includes transmitting or otherwise transferring the formatted video data in a burst mode to a receiving or sink system, such as sink system 120. More particularly, the currently-available frames of video data are sent from the source to the sink in a burst mode rather than provided as a continuous stream of frames of video data padded, if necessary, with idle patterns for rate matching and synchronization with the receiving system, such as receiving system 130. In the burst mode, the video data is transferred at a high bit rate until all the currently-available video data has been transferred to the receiving system memory or buffer, or until the receiving system memory is no longer enabled to receive data, such as, for example, when the buffer is full or is otherwise not enabled. In embodiments, burst mode operation transfers data at or near the maximum throughput capability of the video data link. The burst mode of operation enables the transmission or transfer of variable-sized frames of video data, which may result, for example, from intra-frame compression, and variable rates of frame transfer which may occur, for example, when the display application varies the frame rate. Further, in embodiments, the burst mode transfer may utilize the capabilities of a receiving system having self-refresh capability that enables the display to self-refresh during periods of time when the receiving system memory contains the necessary video data and does not require additional or new video data.

Upon conclusion of the burst transfer of the currently-available video data, method 600 at block 606 enters a reduced power link operating state, such as, for example, one of the exemplary predetermined reduced-power link operating states described and shown in FIG. 1 above, where the link will remain until transfer of currently-available video data is enabled. Method 600, in embodiments, may utilize method 500, shown in FIG. 5, to enter into a reduced-power link operating state and to return to the burst mode transfer of video data, such as, for example, entering into the active link operating state.

More particularly, in embodiments, method 600 may utilize inband command signals, such as a command signal issued on the main video data bus 122, to cause entry into and exit from a reduced-power link operating state, while in other embodiments, method 600 may utilize sideband command signals, such as a command signal issued on AUX signal link 406, to enter into and exit a reduced-power link operating state. It should be particularly noted that the use of inband command signals provides the benefit of eliminating the possibility of a conflict between a command signal for changing link operating states with control or other signals that are typically carried by the AUX signal link 406. It should also be particularly noted that utilizing inband command signals maintains frame synchronization on the video data bus, such as, for example, video data bus 122. Eliminating the possibility of conflicts on the AUX signal link and maintaining link synchronization improves the reliability of burst mode data transfer, reduces the latency in transitioning from a reduced-power link operating state to an active data transfer state, and provides a fixed or known transition time for the link to transition from a reduced-power link operating state to the active data transfer state, thereby increasing the amount of time the link can remain in the reduced-power operating state and enabling entry into a reduced-power link operating state during even brief idle periods all of which, in turn, increase the link power savings that can be achieved.

### Example 1

An electronic device is provided herein that includes a source and sink system for the processing of video data. The electronic device may transfer video data from the source to the sink in high bit rate bursts. Upon completion of the transfer of currently-available video data, the electronic device may enter a mode of operation that reduces its power consumption until transfer of additional currently-available video data is enabled. The electronic device may utilize sideband or inband command signals to enter into and exit from the reduced-power operating states, which may include the predetermined reduced-power link operating states shown in Table 1. The electronic device may include a main video transmitter that transmits the video data and the control signals, and a main receiver that receives the video data and the control signals. Alternatively, the electronic device may include a second, low-power, transmitter that transmits and a second, low-power, receiver that receives the command signals.

### Example 2

A method for the transfer of video data in high bit rate bursts is provided herein. The method includes receiving a pixel stream, transferring the received stream as currently-available frame-formatted video data to a sink in bursts, and entering a reduced-power operating state until transfer of additional currently-available video data is enabled. The method may include issuing inband or sideband command signals to cause the link to enter into and exit from the reduced-power link operating states, which may include the predetermined reduced-power link operating states shown in Table 1.

### Example 3

At least one machine readable medium is provided herein. The readable medium includes instructions stored therein that, in response to being executed on an electronic device, cause the electronic device to receive a stream of pixel data, transfer the stream as currently-available frame-formatted video data in bursts to a sink and, upon completion of the transfer of the currently-available video data, enter one of a plurality of operating states that reduce the power consumption of the device consumption until transfer of additional currently-available video data is enabled. The instructions, in response to being executed on an electronic device, may also cause the device to issue inband or sideband command signals to cause the device to enter into and exit from the reduced-power operating states, which may include the predetermined reduced-power operating states shown in Table 1.

It is to be understood that specifics in the aforementioned examples may be used anywhere in one or more embodiments. For instance, all optional features of exemplary devices described above may also be implemented with respect to any of the other exemplary devices and/or the method described herein. Furthermore, although flow diagrams and/or state diagrams may have been used herein to describe embodiments, the present techniques are not limited to those diagrams or to their corresponding descriptions. For example, the illustrated flow need not move through each box or state or in exactly the same order as depicted and described.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. An electronic device, comprising:
a source system and a sink system, the source system to receive a pixel stream and format the pixel stream into frames of currently-available video data, the source system to transfer the currently-available video data to the sink system in a burst at a high-speed data rate.

2. The electronic device of claim 1, the source system further comprising logic to analyze characteristics of the currently-available video data and, based at least in part upon those characteristics, to enter the electronic device into and exit from a reduced-power operating state.

3. The electronic device of claim 2, wherein the characteristics of the currently-available video data that are analyzed include the inter-frame idle duration.

4. The electronic device of claim 3, wherein the reduced-power operating state comprises one of a plurality of predetermined reduced-power operating states, the reduced-power operating state into which the electronic device is entered being selected based at least in part upon the inter-frame idle duration of the currently-available video data.

5. The electronic device of claim 4, wherein a command-enter signal is to be issued by the source system and transferred to the sink system to cause the source and sink systems to enter the reduced-power operating state, a command-exit signal to be issued by the source system and transferred to the sink system to cause the source and sink systems to exit the reduced-power operating state.

6. The electronic device of claim 5, wherein the command-enter and command-exit signals comprise inband signals.

7. The electronic device of claim 5, further comprising a first transmitter and a first receiver, the first transmitter to transfer the currently-available video data to the first receiver, and a second transmitter and a second receiver, the second transmitter to transfer the command-exit signal to the second receiver.

8. The electronic device of claim 7, wherein the second transmitter and second receiver comprise a respective low power transmitter and a low power receiver relative to a power level of the first transmitter and first receiver.

9. The electronic device of claim 8, wherein the command-exit signal comprises a low frequency periodic signal, or a DC signal of variable pulse duration, to be issued by the second transmitter to the second receiver.

10. The electronic device of claim 1, wherein the sink system includes one of a video display panel, television, computer display, and a video recorder.

11. A method for processing video data in an electronic device, comprising:
receiving, at the electronic device, a stream of pixel data;
formatting, by the electronic device, the pixel data into frames of currently-available video data;
transferring the currently-available video data from the electronic device to a receiving system in a high data rate burst; and
entering the electronic device into a reduced-power operating state upon one of completion of the transferring of currently-available video data to the receiving system and a pause in the transferring of currently-available video data.

12. The method of claim 11, further comprising exiting the reduced-power operating state and entering an active operating state when transfer of additional currently-available video data is enabled.

13. The method of claim 11, wherein the reduced-power operating state comprises a plurality of predetermined reduced-power operating states, the method further comprising selecting the reduced-power operating state from the plurality of predetermined reduced-power operating states dependent at least in part upon inter-frame idle duration of the currently-available video data.

14. The method of claim 11, further comprising issuing a command-enter signal to cause the electronic device to enter the reduced-power operating state and a command-exit signal to return the electronic device to the active operating state.

15. The method of claim 14, wherein at least one of the command-enter and command-exit signals comprises a low-power inband signal.

16. A method for reducing power consumption in an electronic video-processing device, comprising:
receiving, at a source system of the electronic device, a stream of pixel data;
formatting the pixel data into frames of currently-available video data;
transferring, in a high data bit rate burst, the currently-available video data to a sink system of the electronic device; and
entering the electronic device into a reduced-power operating state upon occurrence of one of completion of transferring and a pause in transferring.

17. The method for reducing power consumption of claim 16, wherein entering the electronic device into a reduced-power operating state comprises analyzing inter-frame idle duration of the currently-available video data.

18. The method for reducing power consumption of claim 17, further comprising the electronic device issuing an inband command signal to cause the device to enter the reduced-power operating state.

19. The method for reducing power consumption of claim 18, further comprising exiting from the reduced-power operating state and entering an active operating state upon a resumption of transferring.

20. At least one non-transitory machine readable medium having instructions stored therein that, in response to being executed on an electronic device, cause the electronic device to:
format a received stream of pixel data into frames of currently-available video data;
transfer the currently-available video data from the electronic device to a receiving system in a high data rate burst; and
enter into a reduced-power operating state upon one of completion of the transfer of currently-available video data to the receiving system and a pause in the transfer.

21. The machine readable medium of claim 20, further comprising determining inter-frame idle duration and, dependent at least in part thereon, entering into the reduced-power operating state.

22. The machine readable medium of claim 21, wherein the instructions further cause the electronic device to exit the reduced-power operating state and enter an active operating state when transfer of additional currently-available video data is enabled.

23. The machine readable medium of claim 22, wherein the reduced-power operating state comprises a plurality of predetermined reduced-power operating states, the method further comprising selecting the reduced-power operating state from the plurality of predetermined reduced-power operating states dependent at least in part upon the inter-frame idle duration of the currently-available video data.

24. The machine readable medium of claim 23, wherein the instructions further cause the electronic device to issue at least one inband signal to change operating states.
